(19) United States
(12) Patent Application Publication
(10) Pub. No.: US 2018/0045972 A1
(43) Pub. Date: Feb. 15, 2018

(54) AERIAL DISPLAY AND IMAGE FORMING SYSTEM HAVING THE SAME

(71) Applicant: HON HAI PRECISION INDUSTRY CO., LTD., New Taipei (TW)

(72) Inventors: Feng-Yuen Dai, Tu-Cheng (TW); Chau-Jin Hu, Tu-Cheng (TW); Po-Chou Chen, Tu-Cheng (TW); Bing-Heng Lee, New Taipei (TW)

(21) Appl. No.: 15/261,981

(22) Filed: Sep. 11, 2016

(30) Foreign Application Priority Data
Aug. 15, 2016 (TW) 105125990

(51) Int. Cl. G02B 27/22; G02B 17/00

(52) U.S. Cl. CPC G02B 27/2292; G02B 27/2221; G02B 17/006

(57) ABSTRACT

An aerial display includes a first display layer and a second display layer formed thereon. The first display layer includes first strips stacked and extending along a first direction. Each two adjacent first strips define an air gap. The second display layer includes second strips stacked and extending along a second direction perpendicular to the first direction. Each two adjacent second strips define an air gap. A refractive index of each of the first strips and the second strips is greater than that of the air gap, thereby causing light entering the light incident surface with an incident angle to be totally reflected by a contacting surface of each of the plurality of first strips and an adjacent air gap, or/and a contacting surface of each of the plurality of second strips and an adjacent air gap.

The subject matter relates to displays, and particularly, to an aerial display and an image forming system having the aerial display.

### BACKGROUND

Aerial displays can generate images that appear to float in the air. For example, the aerial display can include a dihedral corner reflector array (DCRA) which uses a plurality of dihedral corner reflectors disposed in an array to generate the images. Although this type of aerial display is useful, the method for making the aerial display may be costly. Therefore, there is room for improvement within the art.

### BRIEF DESCRIPTION OF THE DRAWINGS

Implementations of the present technology will now be described, by way of example only, with reference to the attached figures.

FIG. 1 is a diagrammatic view of an exemplary embodiment of an imaging system having an aerial display.

FIG. 2 is a diagrammatic view of the aerial display of FIG. 1 after a mounting frame is removed.

FIG. 3 is diagrammatic view showing light entering and exiting out of the aerial display of FIG. 2.

FIG. 4 is similar to FIG. 3, but showing light of another direction entering and exiting out of the aerial display.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

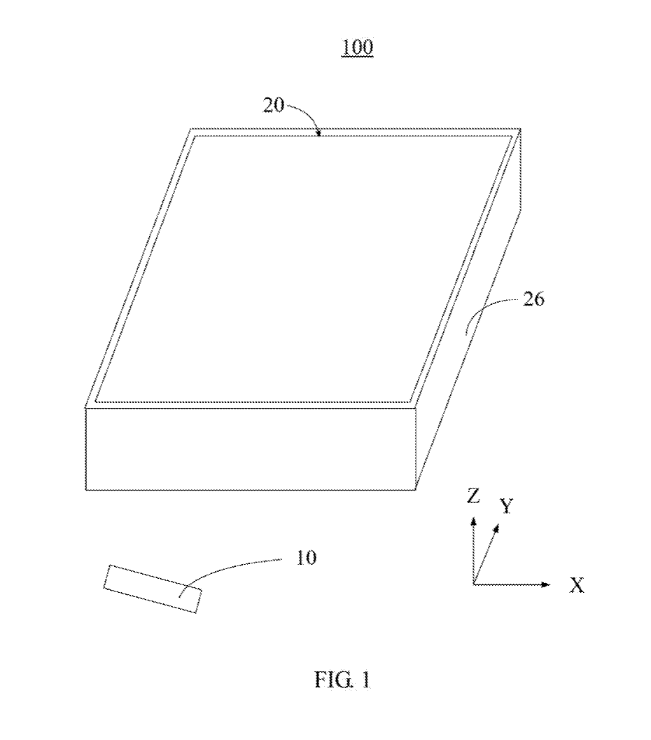

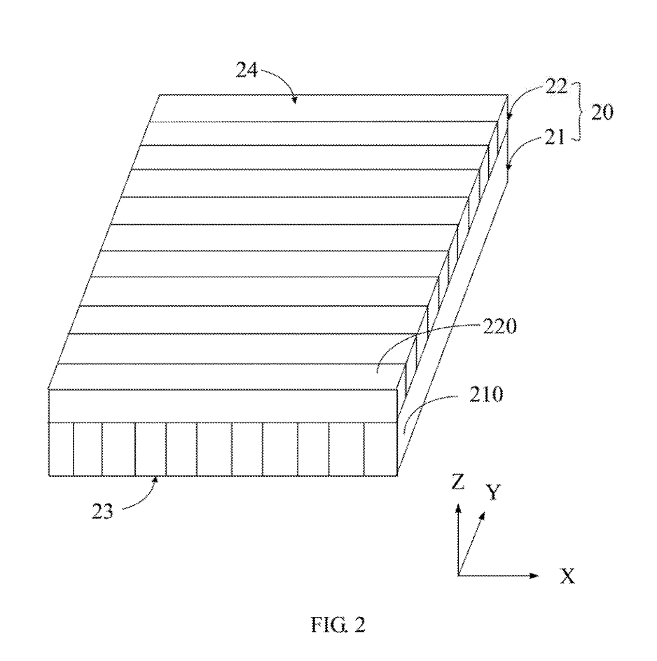

FIGS. 1-2 illustrate an exemplary embodiment of an imaging system comprising an image source 10 and an aerial display 20.

The image source 10 generates images. In at least one exemplary embodiment, the image source 10 is a liquid crystal display (LCD).

The aerial display 20 comprises a first display layer 21 and a second display layer 22 formed on the first display layer 21. A surface of the first display layer 21 positioned at an opposite end of the first display layer 21 facing away from the second display layer 22 forms a light incident surface 23. A surface of the second display layer 22 positioned at an opposite end of the second display layer 22 facing away from the first display layer 21 forms a light exiting surface 24. The image source 10 is adjacent to and faces the light incident surface 23.

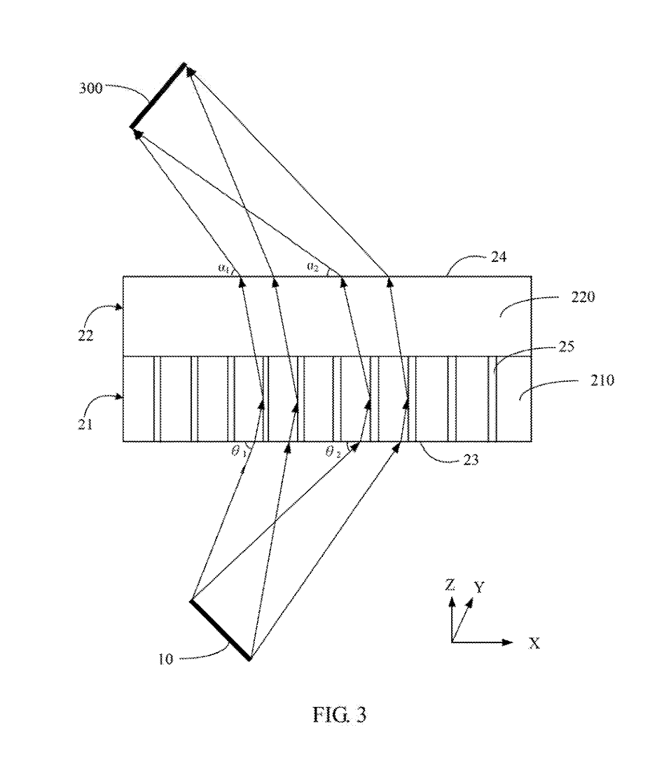

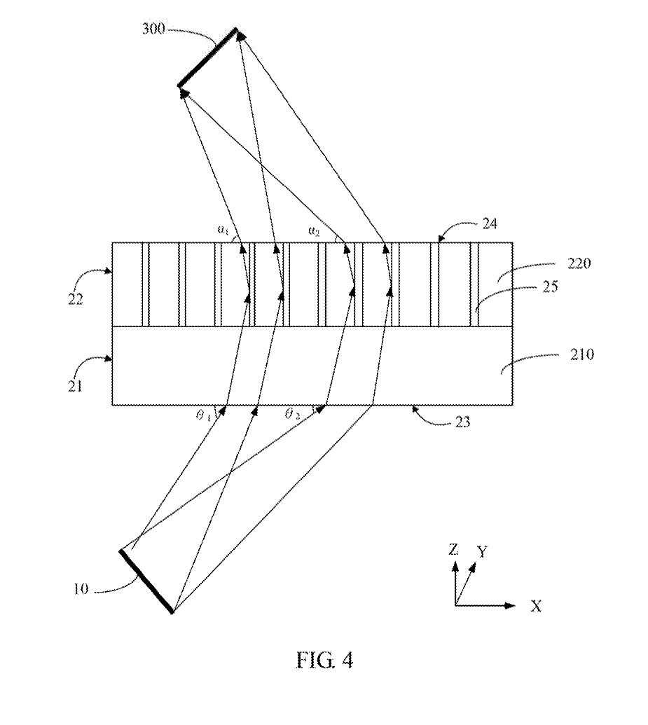

The first display layer 21 comprises a plurality of first strips 210 extending along a first direction (the Y direction of the coordinate system shown in FIG. 1) and arranged in stacks. The second display layer 22 comprises a plurality of second strips 220 extending along a second direction (the X direction of the coordinate system shown in FIG. 1) perpendicular to the first direction. As with the plurality of first strips 210, the plurality of second strips 220 are also arranged in stacks. Each two adjacent first strips 210 define an air gap 25 (see FIG. 3), and each two adjacent second strips 220 define an air gap 25 (see FIG. 4). A refractive index of each of the first strips 210 and the second strips 220 is greater than that of the air gap 25, thereby causing light entering the light incident surface 23 with a particular incident angle to be totally reflected by a contacting surface of each first strip 210 and the adjacent air gap 25, or/and a contacting surface of each second strip 220 and the adjacent air gap 25. As such, the light exits out of the light exiting surface 24 with an exiting angle which is equal to the incident angle (that is, as shown in FIG. 3, α₁=θ₁, α₂=θ₂).

FIGS. 3-4 illustrate, in at least one exemplary embodiment, when the light enters the light incident surface 23, a portion of the light which is parallel to a plane defined by the first direction and the second direction (that is, parallel to the X-Z plane as shown in FIG. 3) is totally reflected by the contacting surface of each first strip 210 and the adjacent air gap 25, passes through the second display layer 22, and exits out of the light exiting surface 24. A portion of the light which is parallel to a plane perpendicular to the first direction (that is, parallel to the Y-Z plane as shown in FIG. 4) passes through the first display layer 21, is totally reflected by the contacting surface of each second strip 220 and the adjacent air gap 25, and exits out of the light exiting surface 24.

In at least one exemplary embodiment, the refractive index of each of the first strips 210 and of the second strips 220 is greater than 1. The refractive index of the first strip 210 can be equal to that of the second strip 220.

In at least one exemplary embodiment, the first strips 210 and the second strips are made of glass. The refractive index of each of the first strips 210 and of the second strips is greater than 1.52.

When the image source 10 generates images, the light from the images enters the light incident surface 23, and is totally reflected by the contacting surface of each first strip 210 and the air gap 25, and/or the contacting surface of each second strip 220 and the air gap 25, exits out of the light exiting surface 24, and converges to form images on the imaging forming surface 300 adjacent to light exiting surface 24. As such, users can observe images that appear to float in the air and mirror-symmetrical with respect to the images generated by the image source 10.

In at least one exemplary embodiment, the aerial display 20 further comprises a mounting frame 26 which surrounds edges of the first strips 210 and the second strips 220, thereby securing the first strips 210 to the second strips 220.

With the above configuration, since the first strips 210 and the second strips 220 can be formed of glass sheets cut by laser, and the first display layer 21 and the second display layer 22 can be formed by stacking the first strips 210 and the second strips 220 together. The aerial display 20 can thus be made by a relatively simple process, and the cost thereof is lowered.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments, to the full extent indicated by the plain meaning of the terms in which the appended claims are expressed.

What is claimed is:

1. An aerial display comprising:
a first display layer, the first display layer comprising a plurality of first strips extending along a first direction and arranged in stacks, each two adjacent first strips defining an air gap; and
a second display layer, the second display layer formed on the first display layer and comprising a plurality of second strips extending along a second direction perpendicular to the first direction and arranged in stacks, each two adjacent second strips defining an air gap;
wherein a surface of the first display layer positioned at an opposite end of the first display layer facing away from the second display layer forms a light incident surface, a surface of the second display layer positioned at an opposite end of the second display layer facing away from the first display layer forms a light exiting surface; and
wherein a refractive index of each of the plurality of first strips and the plurality of second strips is greater than that of the air gap, thereby causing light entering the light incident surface with an incident angle to be totally reflected by a contacting surface of each of the plurality of first strips and an adjacent air gap, or/and a contacting surface of each of the plurality of second strips and an adjacent air gap, so that the light exits out of the light exiting surface with an exiting angle which is equal to the incident angle.

2. The aerial display of claim 1, wherein the contacting surface of each of the plurality of first strips and the adjacent air gap is configured to totally reflect a portion of the light which is parallel to a plane defined by the first direction and the second direction, and the contacting surface of each of the plurality of second strips and the adjacent air gap is configured to totally reflect a portion of the light which is parallel to a plane perpendicular to the first direction.

3. The aerial display of claim 1, wherein the refractive index of each of the plurality of first strips and the plurality of second strips is greater than 1.

4. The aerial display of claim 1, wherein the plurality of first strips and the plurality of second strips are made of glass, and the refractive index of each of the plurality of first strips and the plurality of second strips is greater than 1.52.

5. The aerial display of claim 1, further comprising a mounting frame which surrounds edges of the plurality of first strips and the plurality of second strips, thereby securing the plurality of first strips to the plurality of second strips.

6. An image forming system comprising:
an image source configured to generate images; and
an aerial display comprising:
a first display layer, the first display layer comprising a plurality of first strips extending along a first direction and arranged in stacks, each two adjacent first strips defining an air gap; and
a second display layer, the second display layer formed on the first display layer and comprising a plurality of second strips extending along a second direction perpendicular to the first direction and arranged in stacks, each two adjacent second strips defining an air gap, a surface of the first display layer at an opposite end of the first display layer facing away from the second display layer forming a light incident surface, a surface of the second display layer at an opposite end of the second display layer facing away from the first display layer forming a light exiting surface, the image source adjacent to and facing the light incident surface;
wherein a refractive index of each of the plurality of first strips and the plurality of second strips is greater than that of the air gap, thereby causing light from the images entering the light incident surface with an incident angle to be totally reflected by a contacting surface of each of the plurality of first strips and an adjacent air gap, or/and a contacting surface of each of the plurality of second strips and an adjacent air gap, so that the light exits out of the light exiting surface with an exiting angle which is equal to the incident angle, and converges to form images on an image forming surface adjacent to light exiting surface to form images that appear to float in the air.

7. The image forming system of claim 6, wherein the image source is a liquid crystal display.

8. The image forming system of claim 6, wherein the contacting surface of each of the plurality of first strips and the adjacent air gap is configured to totally reflect a portion of the light which is parallel to a plane defined by the first direction and the second direction, and the contacting surface of each of the plurality of second strips and the adjacent air gap is configured to totally reflect a portion of the light which is parallel to a plane perpendicular to the first direction.

9. The image forming system of claim 6, wherein the refractive index of each of the plurality of first strips and the plurality of second strips is greater than 1.

10. The image forming system of claim 6, wherein the plurality of first strips and the plurality of second strips are made of glass, and the refractive index of each of the plurality of first strips and the plurality of second strips is greater than 1.52.

11. The image forming system of claim 6, wherein the aerial display further comprises a mounting frame which surrounds edges of the plurality of first strips and the plurality of second strips, thereby securing the plurality of first strips to the plurality of second strips.
